(19) United States
(12) Patent Application Publication
(10) Pub. No.: US 2004/0064013 A1
(43) Pub. Date: Apr. 1, 2004

(54) Incubator and incubation method monitoring the organism to be incubated

(76) Inventor: Daniel Attias, Levallois-Perret (FR)

Correspondence Address: IP DEPARTMENT OF PIPER RUDNICK LLP, 3400 TWO LOGAN SQUARE, 18TH AND ARCH STREETS, PHILADELPHIA, PA, 19103, US

(21) Appl. No.: 10/635,278

(22) Filed: Aug. 6, 2003

Related U.S. Application Data
(63) Continuation of application No. PCT/FR02/00511, filed on Feb. 11, 2002.

(30) Foreign Application Priority Data
Feb. 9, 2001 (FR) 01/01779

(51) Int. Cl. A61G 11/00

(52) U.S. Cl. 600/22

(57) ABSTRACT

An incubator including a substantially airtight heated chamber equipped with a door to access the heated chamber; a culture plate with multiple wells placed in the heated chamber, the culture plate being adapted to contain an organism in at least one of the wells; and means associated with the heated chamber and controlled from the exterior to remove the organism from a well in which it is contained to put it in another well filled with new culture medium.

### RELATED APPLICATION

This is a continuation of International Application No. PCT/FR02/00511, with an international filing dated of Feb. 11, 2002, which is based on French Patent Application No. 01/01779, filed Feb. 9, 2001.

### FIELD OF THE INVENTION

This invention pertains to incubators and methods for incubating organisms. The invention applies most particularly to culturing embryos and monitoring them under optimal temperature and atmospheric conditions for their development.

### BACKGROUND

The spermatozoids and ovules are brought together during in vitro fertilization. After this fertilization by conventional in vitro fertilization or microinjection, the gametes are deposited on culture media and placed in an incubator. They are pulled out daily, once or twice a day, to change the medium, implement microscopic observation or any other procedure, including in utero transfer of the embryo.

The embryonic cultures are exposed to numerous problems during these various changes of medium and microscopic observations or any other procedure, which are:

thermal shocks of 37° C. (temperature of the incubator) to 20° C. (ambient temperature at which the medium change and microscopic observation are performed),

variations in the concentration of CO₂ which lead to variations in the pH of the culture media,

deterioration in nutritional properties due to temperature variations with the appearance of products that are toxic for the embryo,

exposure of the embryos to light during their microscopic observations,

procedures which are traumatic for the embryos,

risks of bacterial and mycological contamination,

delayed change of medium which leads to an increase in the concentration of free radicals and a decrease in the substrate concentration, and/or

handling errors with loss of embryos.

Certain of the problems cited above confronting the embryos can have very harmful effects on them. In fact, it has been shown that an embryo placed for more than three minutes at a temperature of 22° C. is no longer capable of development.

### SUMMARY OF THE INVENTION

The invention resolves these drawbacks by an incubator and an incubation method that eliminate thermal shocks and the risks of bacterial and mycological contamination while facilitating the change of medium by automating it in a manner to decrease handling errors and traumatic handling operations. The invention used in the framework of in vitro fertilization, thus, makes it possible to improve the number of viable embryos of good quality.

The invention relates to an incubator including a substantially airtight heated chamber equipped with a door to access the heated chamber, a culture plate with multiple wells placed in the heated chamber, the culture plate being adapted to contain an organism in at least one of the wells, and means associated with the heated chamber and controlled from the exterior to remove the organism from a well in which it is contained to put it in another well filled with new culture medium.

The invention also relates to a method of incubating an organism including placing the organism into a substantially airtight, heated chamber, incubating the organism in a culture well filled with culture medium, and changing the culture medium n times, n being a whole number larger than 1 and smaller than 50, by placing the organism in one of a series of (n+1) wells of a culture plate placed in the heated chamber, while the n other wells of the series do not contain any organisms, displacing the organism, without removing it from the heated chamber, from the well in which it was contained and putting it into the next well of the series filled with new culture medium and repeating the displacement as many times as there remain available wells.

### BRIEF DESCRIPTION OF THE DRAWINGS

Other advantages and characteristics of the invention will become apparent from the examples below pertaining to particular modes of implementation of the invention in which reference is made to:

FIG. 1, which represents a schematic sectional view of an incubator according to aspects of the invention, and

FIGS. 2 and 3, which represent two different types of incubators according to aspects of the invention.

### DETAILED DESCRIPTION

It will be appreciated that the following description is intended to refer to specific embodiments of the invention selected for illustration in the drawings and is not intended to define or limit the invention, other than in the appended claims.

In the framework of the invention, the term “organism” is understood to mean not only gametes (oocytes and spermatozoids), fertilized oocytes, embryo cultures and embryos, but also any cell culture such as stem cells, pathogenic or nonpathogenic microorganisms and the like.

Thus, one aspect of the invention is an incubator comprising a substantially airtight heated chamber equipped with a door, a culture plate with multiple wells placed in the heated chamber, an organism being contained in one of the wells of said plate, characterized in that it comprises a means controlled from the exterior designed to remove the organism from the well containing it to place it in another well filled with new culture medium. In the framework of the invention, the means controlled from the exterior designed to remove the organism from the well and put it in another well filled with new culture medium is advantageously a pipette.

Thus, it is no longer necessary to remove the culture plate to remove the organism, notably the embryo, from its well, replace the culture medium and replace the embryo in the well. It is now possible, without removing the embryo from the incubator, to remove it from the well containing it and put it in a subsequent well filled with culture medium that has not yet come into contact with an embryo and is, therefore, free from toxins. This medium will be referred to below as “new culture medium”. The passage of the embryo from one culture well to the next well can be performed with precision, even though the heated chamber remains closed, by means of a microscope which enables monitoring operations on the display screen. The evolution of the organisms can be monitored as frequently as desired without the monitoring operations causing harm.

The microscope is mounted in the interior or on the exterior of the heated chamber in a manner to enable observation of the organism culture and monitor the various handling operations (transfer of the organism from one well to another and filling of the wells), the microscope being linked to a display screen exterior to the heated chamber. Irrespective of whether the microscope is in the interior or on the exterior of the heated chamber, in both cases the stage of the microscope is in the interior of the heated chamber. If the microscope is in the interior of the heated chamber, a protective case may be necessary to allow it to operate under the conditions of temperature and concentrations of N₂, O₂ and CO₂ inside the heated chamber. The microscope used in the framework of the invention advantageously has a filter that protects the organism from the deleterious effects of the light during microscope observations. The incubator accepts variants with a microscope with a fixed or mobile stage and/or a microscope with a fixed or mobile axis.

The incubator can be divided into zones and comprises at least:

an “intervention zone” dedicated to observation and the various embryo handling operations (medium filling and changing wells),

an “incubation zone” dedicated to storage of culture plates, and

an additional zone which can be common with the “intervention zone” and which is dedicated to storage of consumables (culture medium, cones) and the evacuation of waste products.

The three different zones can be on the same level or on different levels.

The incubator comprises means controlled from the exterior of the heated chamber for the stepwise displacement in the heated chamber of the multiple-well culture plates. Any means of stepwise displacement of a culture plate can be used in the framework of the invention. The displacement means used is advantageously constituted by:

an endless conveyor belt driven by a motor roller, which is itself driven in rotation by a stepping motor controlled by a computer via a command line,

an articulated manipulator arm controlled by a computer and capable of grasping the culture plate to be processed and of carrying it to the intervention zone; the manipulator arm can engage in linear or rotary displacement.

It is possible to fill all of the wells in the heated chamber in advance with culture medium. However, to prevent the culture medium from evaporating or becoming contaminated even before the embryo has been placed in the well, it is preferred that the incubator comprise a source of culture medium communicating with a sluiced duct opening above a well and means for controlling the sluice to release a specified amount of culture medium into the well. The source of medium can be outside the incubator or can be provided inside the incubator, e.g., in a zone dedicated to storing consumables. The well in question is filled with culture medium just before it receives the embryo. The duct opening above the well is preferably at the position which makes it possible to monitor operations by means of the microscope.

According to another mode of implementation which is also preferred, the duct opens above the well just upstream of the well at the position. It is, thus, possible to simultaneously perform the filling of this upstream well and remove the embryo from the well by suctioning with the pipette. There is also more room for the entry of the duct above this well.

It is also contemplated that the incubator comprises means for displacement of the sluice useful for filling medium from one well to another.

Other means for filling the wells of the culture plates with medium are contemplated. It is also contemplated that the use of a motorized syringe controlled from the exterior which suctions the medium directly in a flask in the zone dedicated to the storage of consumables and distributes it into the well by reversing the motorization of the syringe. The medium to be distributed can also be taken from a flask by a collection system controlled from the exterior such as, for example, a single-use cone, then distributed into the well.

The heated chamber advantageously has conditions of temperature and concentrations of N₂, O₂ and CO₂ that are ideal for developing cell cultures and, more particularly, embryo cultures. These conditions are advantageously a temperature of about 37° C. and an atmosphere of about 5% of O₂, about 5% of CO₂ and about 90% of N₂. The incubator is advantageously equipped with sensors for the autoregulation and monitoring of the interior atmosphere of the heated chamber. These sensors make it possible to monitor the temperature and the concentration of N₂, O₂ and CO₂ during the entire duration of the culture. Any sensor capable of measuring the variations of temperature and concentrations of N₂, O₂ and CO₂ under the conditions of the heated chamber can be used.

The invention also pertains to a method for incubating an organism which comprises putting the organism in a substantially airtight heated chamber, incubating it in a culture well filled with a culture medium and changing the culture medium n times, n being a whole number greater than 1 and smaller than 50, characterized in that it consists of:

i) putting the organism in one of a series of (n+1) wells in a plate placed in a heated chamber while the n other wells of the series are free from organisms,

ii) displacing the organism from the well containing it without removing it from the heated chamber to put it in the next well in the series filled with new culture medium, and

iii) repeating the displacement at least as many times as there remain available wells.

All of the operations are performed in the interior of the incubator under the monitoring of the microscope and can be controlled automatically by a computer.

To remove the embryo, the pipette is placed in the well at the position observed by the microscope, the organism is suctioned up, the pipette is removed from the well, the next well is brought to said position, the pipette is plunged into this new well, the embryo is released from the pipette into the well and the pipette is withdrawn from the well. The handling of the embryo is thereby very controlled, assisted in an automated manner, which greatly reduces the danger of accidents and traumas.

According to a variant, the method comprises observing with the microscope the color change of the culture medium containing an indicator and contained in the well of a series of (n+1) colored wells in which the organism is contained and changing the organism's well when this color change is observed. In fact, the color change of the culture medium to which has been added a colored indicator, notably of pH, e.g., phenol red, is preferably observed frequently or continuously with the microscope. One is, therefore, alerted of the exact moment when it is necessary to change wells. It is also possible for the purpose of monitoring the color change to provide in the heated chamber an optical densitometer and means for transmitting the signal emitted by the densitometer to the exterior of the heated chamber, notably acoustic alert means.

It is also possible to provide for other operations in addition to changing of the culture medium in this device adapted for embryo cultures such as searching for oocytes in follicular fluid, preparation of gametes, oocyte decoronization, microinjection, assisted eclosion and oocyte maturation.

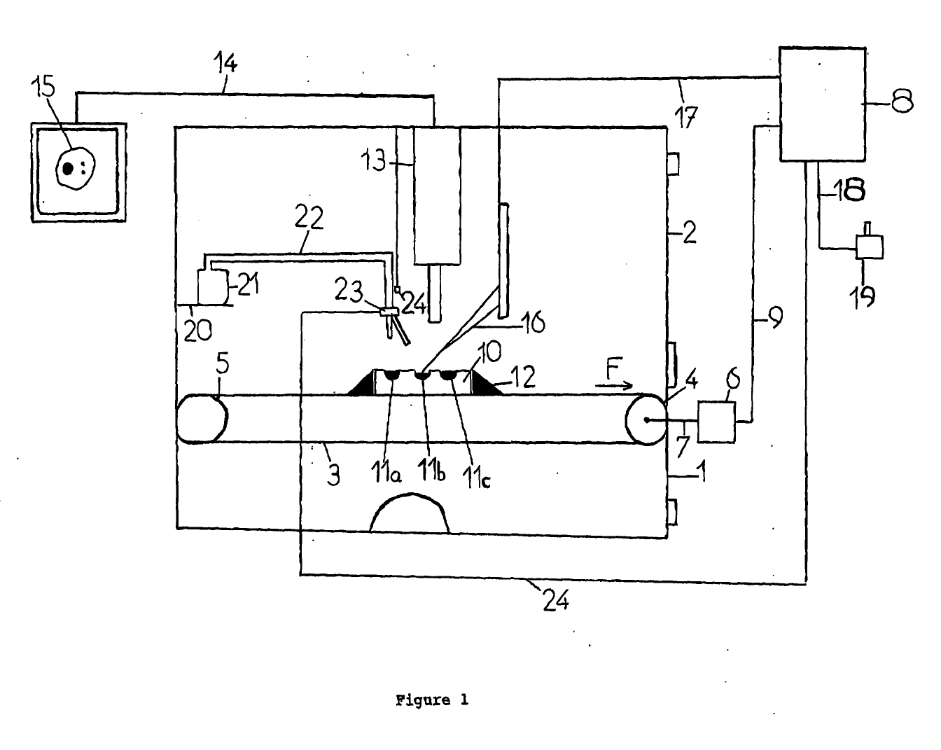

Turning now to the drawings, the schematic sectional view shown in FIG. 1 comprises a substantially airtight heated chamber 1 provided with a door 2 that can be closed in an airtight manner. Inside the heated chamber 1 is mounted an endless conveyer belt 3 driven by a roller 4 and passing over a return idler 5. The roller 4 is driven in rotation by a motor 6 located outside of the heated chamber, but which could also be located inside the heated chamber, and which in the present case is connected to the roller 4 by a line 7. The stepping motor 6 is controlled by a computer 8 via the intermediary of a control line 9. On the top strand of the conveyor 3 is placed a culture plate 10 comprising three wells 11a, 11b and 11c. Well 11a is upstream of well 11b in the direction of arrow F of the conveyor, whereas well 11c is downstream. The plate 10 is maintained on the conveyor 3 by buttresses to prevent unsuitable movements.

Above the position at which well 11b is shown is mounted in a fixed manner a microscope 13 which is connected by a line 14 to a display device 15 so that the well 11b at this position can be seen. Also at this position there is a pipette 16 controlled by the computer 8 via the intermediary of a line 17. The computer 8 is connected via a line 18 to an operating handle 19 for controlling the pipette and especially for making it descend into the well at said position, i.e., well 11b, or to remove the pipette and enabling it to suction up a part of the contents of the well 11b or to release a part from the pipette in the well at that position.

On a bracket 20 provided inside the heated chamber 2 is supported a bottle 21 of culture medium which via a duct 22 equipped with a sluice 23 opens above the well 11a or, according to a variant which is also represented in FIG. 1, above the well 11b, it being understood that only one of these variants would be used not both of them at the same time.

An optical densitometer 24 with a threshold alarm makes it possible to monitor the optical density of the culture medium of well 11b.

To initiate culturing of the embryo, the door 2 of the heated chamber 1 is opened and the embryo is placed in well 11c filled with culture medium in the heated chamber 1, while wells 11a and 11b are empty, it being understood that they could also already be filled with culture medium. Thus, there is a series of three wells 11a, 11b and 11c, only one of which contains an embryo. The door 2 is closed and will not be opened until the culture has been completed. The embryo is allowed to grow in well 11c which is then under the microscope 13 with the possibility, by means of this microscope and optionally the densitometer, to observe the progression of development and, when appropriate, to determine the best time for changing the culture medium. It is also possible to decide to change the culture medium after a predetermined period of time. When it is time to change the culture medium, the pipette 16 is lowered into the well 11c, by means of suction the embryo is brought out of well 11c into the pipette 16, the pipette 16 is withdrawn from well 11c and the conveyor 3 is advanced by one step to now bring well 11b opposite the microscope 13 at the position where well 11c had previously been located. The pipette 16 is then lowered into well 11b to reach the position represented in FIG. 1. Well 11b is then filled with culture medium by means of the bottle 21, the duct 22 and the sluice 23, unless this operation had already previously been performed, and then the pipette 16 is lowered and the embryo is released into well 11b, with these operation being observed on the display device 15 to confirm that they are performed correctly. The pipette 16 is then withdrawn from well 11b. These operations are subsequently repeated but with well 11a taking the place of well 11b and well 11b playing the role previously played by well 11c.

It is possible to modify the well-displacement device to put the wells at the position under the microscope 13, e.g., by means of a revolving stand or other device. It is also possible to provide multiple series of wells 11a, 11b and 11c with a larger number of wells per series and with each series having its own displacement means.

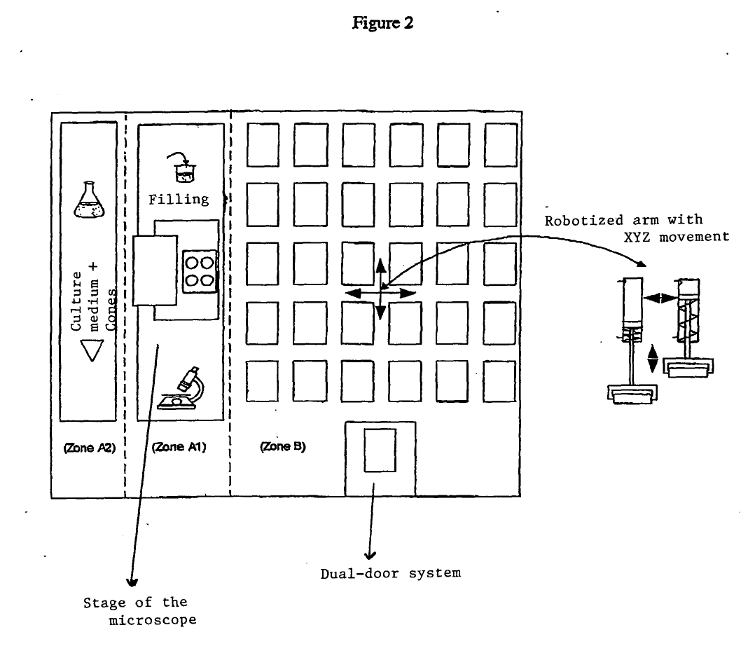

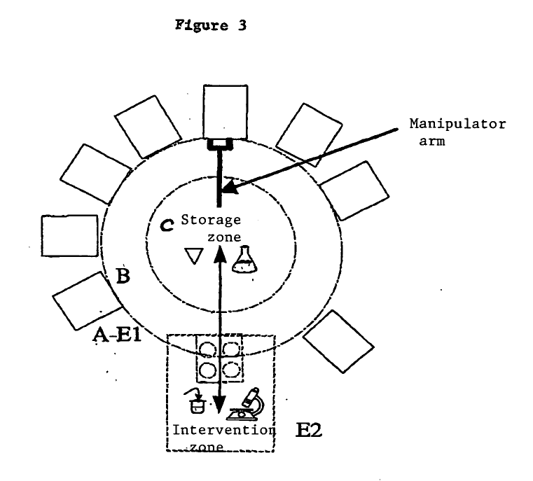

FIGS. 2 and 3 present two types of incubators each capable of containing multiple culture plates.

The incubator of FIG. 2 is an incubator in which the intervention zone (A1), the zone dedicated to the storage of consumables (A2) and the incubation zone (B) are on the same level. An articulated, motorized arm takes the plate to be processed from the incubation zone (B) dedicated to the storage of culture plates and takes it to the intervention zone. In this intervention zone are performed the various operations of the method which are the changing of embryos from well to well and the filling of the wells with culture medium. In this mode of implementation of the invention, only the culture plate to be processed is handled. Furthermore, each of the culture plates is defined by its position (x, y) in the incubation zone which makes it possible to store them in a logical, coherent manner to avoid errors between culture plates and, thus, between cultures.

The incubator of FIG. 3 is a system composed of two levels. The culture plates are stored on the first level (E1). This level, thus, corresponds to the incubation zone (A). The platform is fixed. A dual-door system allows introduction of 4 culture plates simultaneously. The second level (E2) is the intervention level to which access is gained via a manipulator arm. The axis of the microscope is fixed and the stage of the microscope on which is placed the culture plate to be observed can be displaced in the x and y directions, with the microscope capable of displacement in the z direction for focusing. The consumables are stored and the operations of removing culture media and cones and their evacuation are performed at the center of the platform (C).

1. An incubator comprising:
a substantially airtight heated chamber equipped with a door to access the heated chamber;
a culture plate with multiple wells placed in the heated chamber, the culture plate being adapted to contain an organism in at least one of the wells; and
means associated with the heated chamber and controlled from the exterior to remove the organism from a well and to put the organism in another well containing new culture medium.

2. The incubator according to claim 1, wherein the means controlled from the exterior is a pipette.

3. The incubator according to claim 1, further comprising a microscope associated with the heated chamber to observe the organism on a display screen placed exteriorly of the heated chamber.

4. The incubator according to claim 3, wherein the microscope has a stage located inside the heated chamber.

5. The incubator according to claim 3, wherein the microscope has a filter that protects the organism from deleterious effects of light.

6. The incubator according to claim 1, further comprising means controlled from the exterior of the heated chamber for stepwise displacement of the culture plate.

7. The incubator according to claim 6, wherein the means for stepwise displacement of the culture plate comprises either:
an endless conveyor belt driven by a roller rotated by a stepping motor controlled by a computer via a control line, or
an articulated manipulator arm controlled by a computer and capable of picking up the culture plate and moving the culture plate into an intervention zone, with the manipulator having a linear or rotary displacement.

8. The incubator according to claim 1, further comprising a source of culture medium communicating with a sluiced duct opening above a selected well in the culture plate and control means for the sluice to pour into the selected well a selected amount of culture medium.

9. The incubator according to claim 8, further comprising means for displacing the sluice from one well to another.

10. The incubator according to claim 1, further comprising sensors enabling autoregulation and monitoring of the atmosphere inside the heated chamber.

11. A method of incubating an organism:
placing the organism into a substantially airtight, heated chamber;
incubating the organism in a culture well containing culture medium; and
changing the culture medium n times, n being a whole number larger than 1 and smaller than 50, by:
i) placing the organism in one of a series of (n+1) wells of a culture plate placed in the heated chamber, while the n other wells of the series do not contain any organisms,
ii) displacing the organism, without removing it from the heated chamber, from the well and putting the organism into the next well of the series containing new culture medium and
iii) repeating the displacement as many times as there remain available wells.

12. The method according to claim 11, further comprising observing with a microscope color changes in the culture medium containing an indicator and contained in the well of a series of (n+1) colored wells in which the organism is contained and of changing the organism from one well to the next upon observing a color change.

13. The method according to claim 11, further comprising monitoring optical density in the heated chamber and changing wells when the optical density exceeds a specified threshold.
